(19) United States
(12) Patent Application Publication
(10) Pub. No.: US 2007/0130981 A1
(43) Pub. Date: Jun. 14, 2007

(54) EVAPORATIVE COOLING APPARATUS FOR IV FLUIDS

(75) Inventors: Jeremy B. Hyldahl, Clarksville, TN (US); Jennifer L. Johnson, Anderson, SC (US)

Correspondence Address: CAHN & SAMUELS LLP, 2000 P STREET NW, SUITE 200, WASHINGTON, DC, 20036, US

(73) Assignee: Tactical Medical Solutions, LLC, Anderson, SC (US)

(21) Appl. No.: 11/554,977

(22) Filed: Oct. 31, 2006

Related U.S. Application Data
(60) Provisional application No. 60/731,256, filed on Oct. 31, 2005.
(60) Provisional application No. 60/731,252, filed on Oct. 31, 2005.

(51) Int. Cl. F28C 1/00; B01D 47/00; F28D 5/00

(52) U.S. Cl. 62/315; 62/304; 261/100

(57) ABSTRACT

An evaporative cooling apparatus for intravenous fluids comprises a flexible, air permeable sleeve having an interior surface and an exterior surface. A plurality of cooling chambers containing polymer crystals are attached to the inner surface of the air permeable sleeve to facilitate evaporative cooling. Each cooling chamber is spaced from an adjacent cooling chamber.

### I. CROSS REFERENCE TO RELATED APPLICATION

This application claims the benefit of provisional application Ser. No. 60/731,256 filed Oct. 31, 2005, which is incorporated herein by reference.

This application claims the benefit of provisional application Ser. No. 60/731,252 filed Oct. 31, 2005, which is incorporated herein by reference.

### II. FIELD OF THE INVENTION

This invention relates to devices for handling intravenous fluids. More particularly, this invention relates to devices and methods for cooling intravenous fluids.

### II. BACKGROUND OF THE INVENTION

Many healthcare organizations recommend that surgical fluids, including intravenous (IV) fluids, be stored and administered at temperatures at or below about 43° C. Excessively hot IV fluids can cause tissue damage and hemolysis. Hot fluids are also counter-productive when treating heat related illnesses.

In field environments such as desert or any low humidity hot environment, it is not unusual for the ambient temperatures to reach 52.2° C. (126° F.) or above. The administration of fluids at such temperatures can damage tissue and blood cells. Heretofore, military field medics and first responders have used various make-shift devices in an attempt to cool IV fluids including wetting socks and inserting the IV bags into the wet socks. Such methods are crude and cannot be relied upon to reduce the temperature of IV fluids to an acceptable level. Accordingly, there is a need for a device that may be employed in a field environment that can reliable cool IV fluids to a temperature that is safe for patient administration.

### IV. SUMMARY OF THE INVENTION

In accordance with an embodiment of the invention, a cooling apparatus for intravenous fluids comprises a flexible, air permeable sleeve having an interior surface and an exterior surface. A plurality of cooling chambers containing polymer crystals are attached to the inner surface of the air permeable sleeve. Each cooling chamber is spaced from an adjacent cooling chamber.

In accordance with another embodiment of the invention, a cooling apparatus for intravenous fluids comprises a flexible, air permeable sleeve having an interior surface and an exterior surface and an upstream end portion and downstream end portion. An IV bag loop is attached to the interior surface of the sleeve proximate to the upstream end portion. An administration assembly is attached to the sleeve proximate the downstream end portion. A plurality of cooling chambers containing polymer crystals are disposed on the inner surface of the air permeable sleeve, where each cooling chamber is spaced from an adjacent cooling chamber.

In accordance with still another embodiment of the invention, an evaporative cooling apparatus for IV fluids comprises a flexible, air permeable sleeve configured to receive an IV bag where the sleeve has an interior surface and an exterior surface. A plurality of cooling chambers containing polymer crystals are attached to the inner surface of the air permeable sleeve. Each cooling chamber is spaced from an adjacent cooling chamber. An IV bag insertion port is disposed in the sleeve and the insertion port includes a closure mechanism for constricting the sleeve and urging the cooling chambers against an IV bag.

### V. BRIEF DESCRIPTION OF THE DRAWINGS

FIG. 1 depicts a front view of an evaporative cooling apparatus and IV bag in accordance with an embodiment of the present invention.

FIG. 2 shows a sleeve for the evaporative cooling apparatus of FIG. 1.

FIG. 3 illustrates a side view of an evaporative cooling apparatus in accordance with an embodiment of the invention.

FIG. 4 depicts an administration assembly of an evaporative cooling apparatus in accordance with an embodiment of the invention.

FIG. 5 shows a downstream end portion of an evaporative cooling apparatus in accordance with an embodiment of the invention.

FIG. 6 depicts a closure mechanism for an evaporative cooling device in accordance with an embodiment of the invention.

FIG. 7 illustrates an upstream end portion of an evaporative cooling apparatus in accordance with an embodiment of the invention.

FIG. 8 illustrates a rear view of an evaporative cooling apparatus in accordance with an embodiment of the invention.

FIG. 9 illustrates an unassembled view of an evaporative cooling apparatus in accordance with an embodiment of the invention.

FIG. 10 shows a perspective view of an upper end portion of an evaporative cooling apparatus in accordance with an embodiment of the invention.

FIG. 11 depicts a front view of the evaporative cooling apparatus of FIG. 10.

### VI. DETAILED DESCRIPTION OF THE DRAWINGS

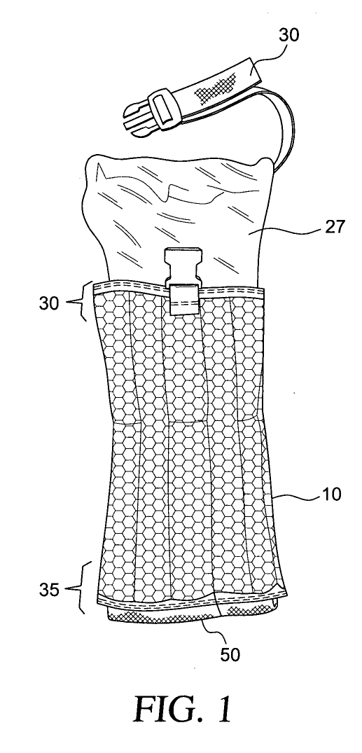

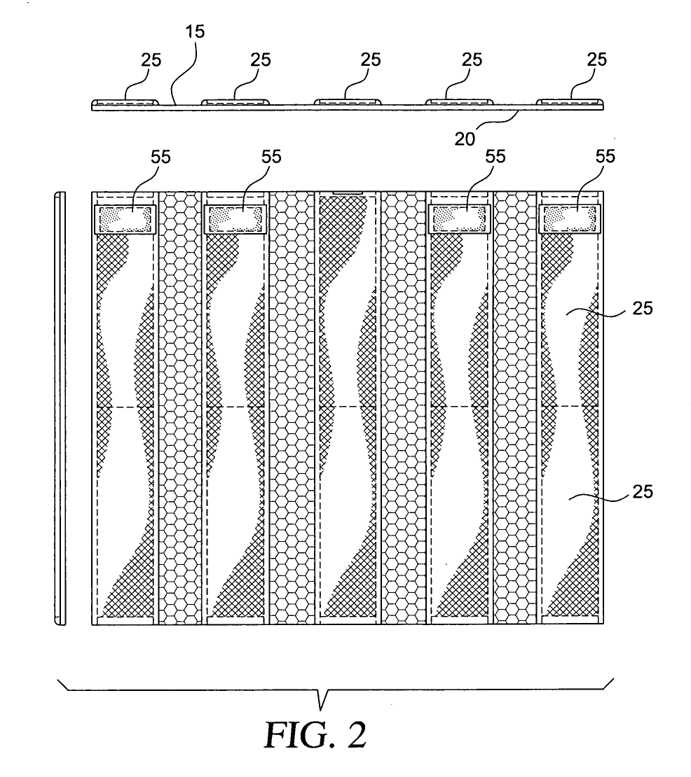

The present invention is generally directed to an apparatus for cooling the fluid contained in intravenous (IV) fluid bags to make the fluid suitable for administration. As illustrated in FIGS. 1 and 2, the apparatus generally includes an air permeable sleeve 10 having an interior surface 15 and an exterior surface 20. A plurality of adjacent absorptive cooling chambers 25 are attached to interior surface 15 to promote maximum contact with fluid container 27. Each cooling chamber 25 preferably includes a cell containing a measured amount of polymer crystals, preferably about one teaspoon. Cooling chambers 25 operate on the principal of evaporative cooling. Accordingly, cooling chambers 25 are preferably comprised of material that will absorb moisture to allow the polymer crystals to become hydrated, Exemplary materials include canvass and cotton. Once the polymer crystals become hydrated, the crystals expand to almost a gel state. Temperature reduction occurs as air circulates over and through cooling chambers 25.

Cooling chambers 25 may be fixedly attached to interior surface 35, for example, by stitching. Alternatively, cooling chambers 25 may be removably attached to interior surface 15 by means of a hook and loop fastener, i.e., Velcro®, by a snap connector or other connection mechanism that permits detachment. Adjacent cooling chambers 25 are preferably spaced from each other to provide a pathway for air circulation.

To facilitate evaporative cooling, sleeve 10 is preferably comprised of a fabric that promotes air circulation. A suitable fabric is a nylon mesh. However, any air permeable fabric may be employed as cooling is increased with greater air circulation.

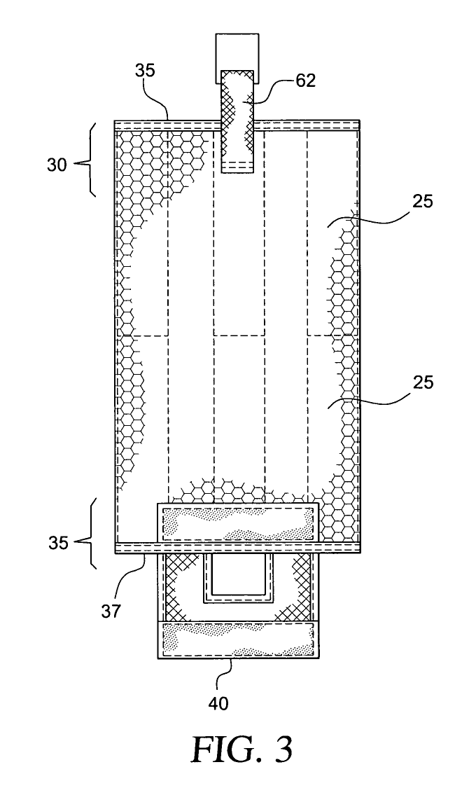

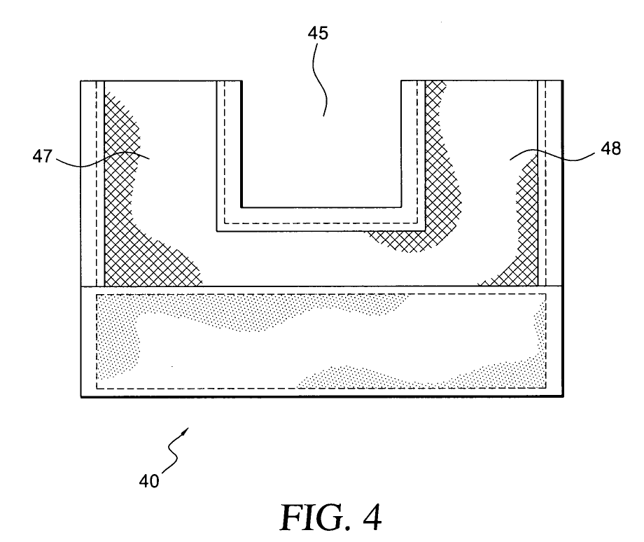

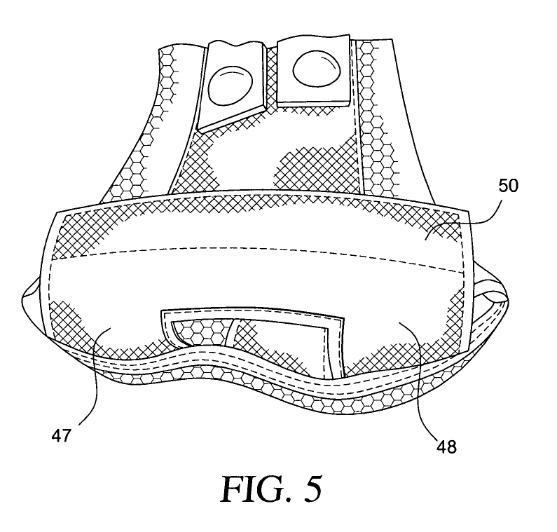

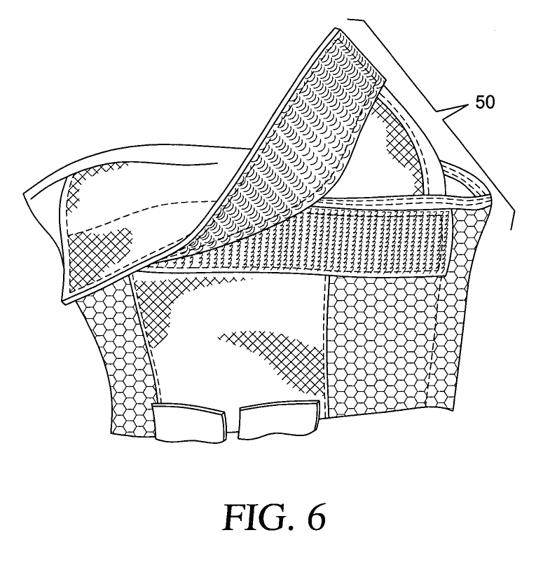

In accordance with an embodiment of the invention, as illustrated in FIG. 3, sleeve 10 preferably comprises a sleeve having an upstream end portion 30 including an opening 33 and a downstream end portion 35 including an opening 37. An administration assembly 40 is disposed on downstream end portion 35. As depicted in FIG. 4, administration assembly 40 includes an administration port and a closure mechanism. The administration port includes an aperture 45 sized to receive an outlet of a standard IV bag. The administration port further includes securing straps 47,48 that extend across the opening 37 and attach to exterior surface 20 of downstream end portion 35 via the closure mechanism 50 as shown in FIG. 5. As shown in FIG. 6, closure mechanism 50 preferably comprise a hook and pile fastener with one of the hook material or the pile material attached to the exterior surface of the downstream end and the other of the hook and pile materials attached to the securing strap. Alternatively, the closure mechanism may include snaps, buttons or any other non-permanent attachment device that facilitates quick, easy operation.

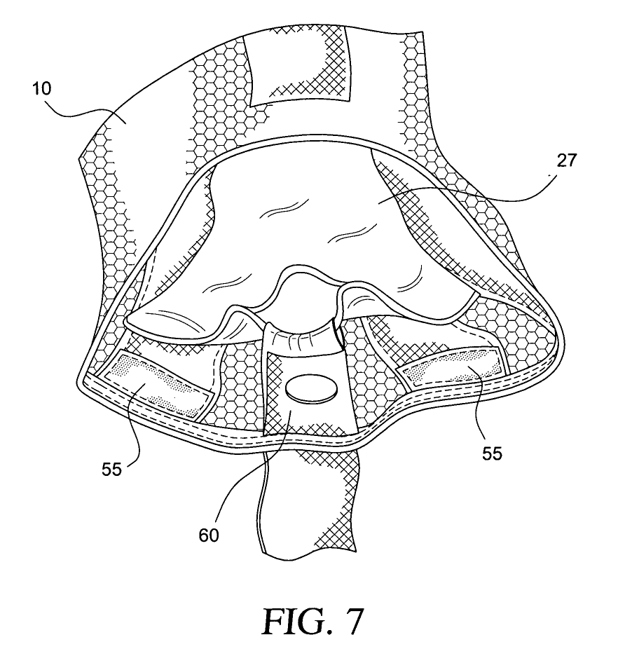

The IV bag 27 may be inserted into sleeve 10 through opening 33 in upstream end portion 30. In order to promote intimate contact between the IV bag 27 and cooling chambers 25, it is desirable to interconnect opposing portions of the interior surface 15 of upstream end portion 30, thereby urging cooling chambers 25 against IV bag 27. Accordingly, as illustrated in FIGS. 2 and 7, interior surface 15 of upper end portion 30 may be provided with fasteners 55, e.g., hook and loop fasteners, snaps, zippers etc. To facilitate proper IV bag placement and assist in fluid administration, a bag hanging loop 60 may be secured to the interior surface of sleeve 10 proximate to upstream end portion 30. Bag hanging loop 60 may be constructed in any one of a number of ways. In accordance with an embodiment of the invention, bag hanging loop 60 includes a strap having a first end attached to the interior surface of sleeve 10 and a second free end. The free end includes one of a male and female portion a snap and the attached end includes the other of a male and female end of a snap. Accordingly, the strap may be threaded through an eyelet in the IV bag 27 as shown in FIG. 7 and closed allowing IV bag 27 to hang in its deployed position.

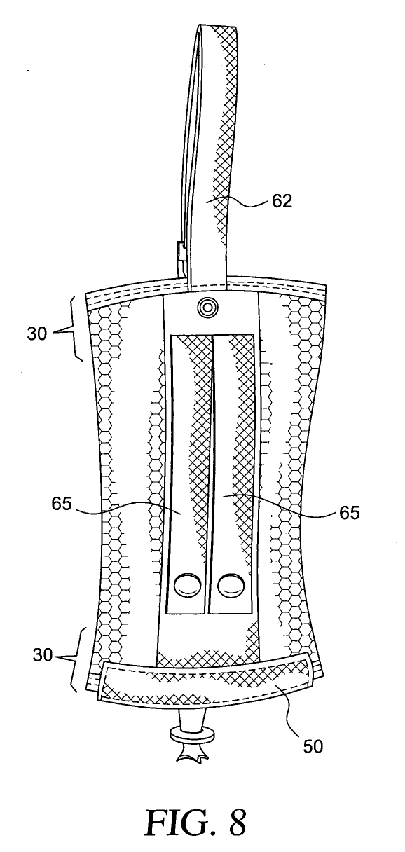

A hanging strap 62 is attached to upstream end portion 30 so that the sleeve 10 and the IV bag 27 can be hung from a hook or cross bar to facilitate IV fluid administration. FIG. 8 shows equipment attachment straps 65 attached to sleeve 10 to facilitate attachment of the cooling device to a tactical vest, a backpack, body armor, etc.

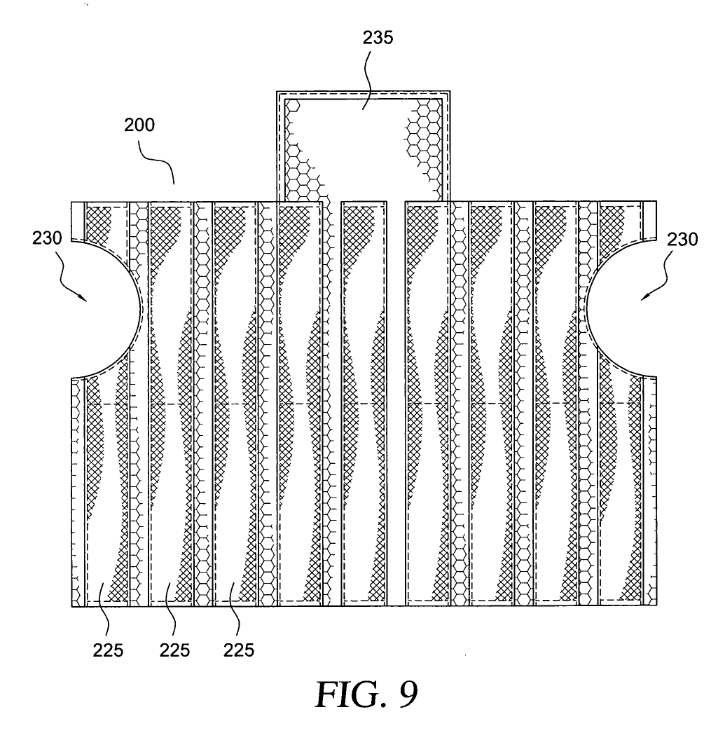

FIG. 9 illustrates an exemplary evaporative cooling device in a disassembled condition in accordance with another embodiment of the invention. Sleeve 200 includes a plurality of cooling chambers 225 and an IV bag insertion port 230. Sleeve 200 further includes a top closure flap 235. Each cooling chamber 225 preferably comprises an aborptive or water permeable cell having a measured amount, approximately one teaspoon for example, of polymer crystals disposed therein.

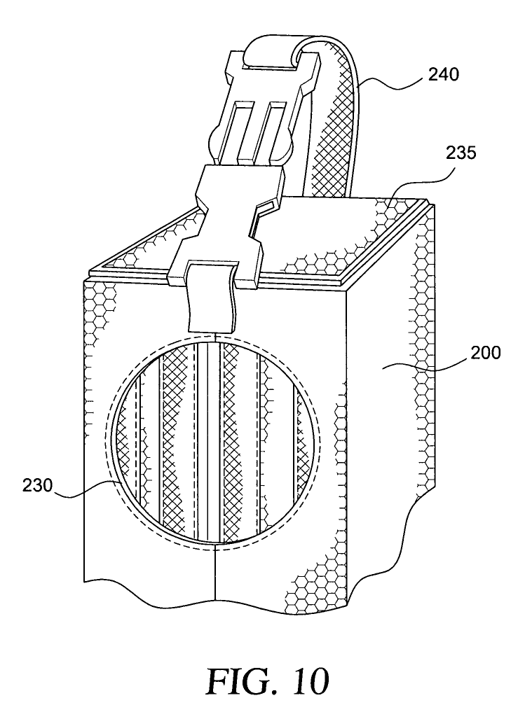

FIG. 10 depicts the evaporative cooling device of FIG. 9 in assembled form. Hanging strap 240 is connected to the upper end portion of sleeve 200 to facilitate hanging the device from hook or crossbar of, e.g., a litter rack, a field litter ambulance, an all terrain vehicle, etc. Although not shown, the bottom end of sleeve 200 is preferably closed.

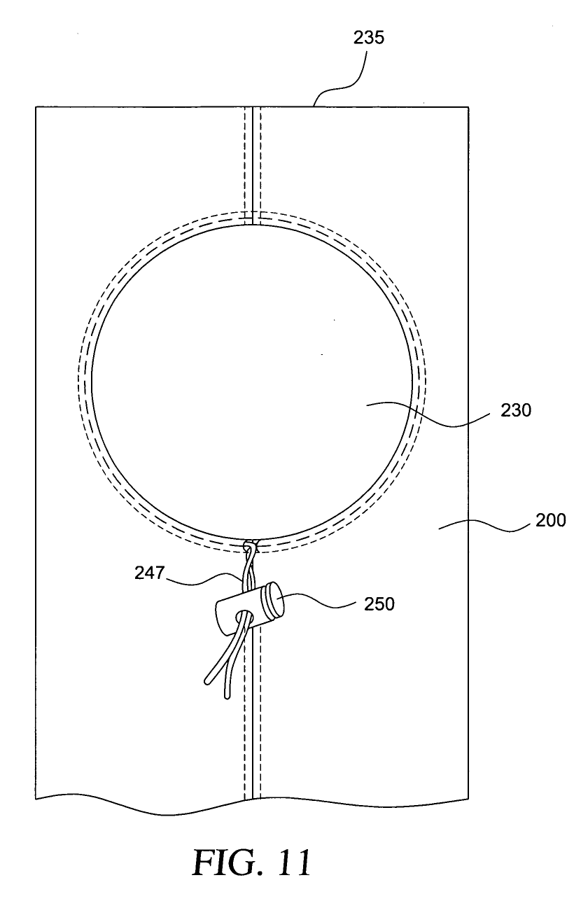

IV bag insertion port 230 comprises an aperture 243 in sleeve 200. To promote intimate contact between the IV bag and cooling chambers 225, IV bag insertion port 230 is preferably provided with a closure mechanism. In the illustrated embodiment illustrated in FIG. 11, a drawstring 247 is threaded through the perimeter of port 230 which the user can pull and tighten sleeve 200 around the IV bag. A clip 250 is provided to set the drawstring in place. In keeping with the invention, any closure mechanism that draws cooling chambers 225 into contact with IV bag 27 is suitable.

While the invention is not restricted to any particular dimensions, in an exemplary embodiment, cooling chambers 225 have a length of about 6 inches and a width of about 1 inch. Adjacent cooling chambers 225 are spaced from each other by a distance of at least about ¾ inch. IV bag insertion port 230 is substantially circular and has a diameter of about 4 inches.

The evaporative cooling device of the present invention may be used in following manner. The device should be fully submerged in water preferably until all cooling chambers are fully expanded with polymer gel. Typically, it takes about 15 minutes for expansion to occur. The IV bag is then inserted into the sleeve. In the embodiment depicted in FIG. 1-9, inserting the IV bag into the sleeve includes threading the IV bag strap through the eyelet at the top of the IV bag and securing the IV bag strap. Further, the drug/needle and drip set port of the IV bag is guided through the IV port and the IV port assembly is secured to the sleeve. The device and the bag, in combination, may then be hung from a crossbar or hook, preferably in a well ventilated area, to facilitate fluid administration.

Although shown and described is what is believed to be the most practical and preferred embodiments, it is apparent that departures from specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

We claim:

1. A cooling apparatus for intravenous fluids comprising:
a flexible, air permeable sleeve having an interior surface and an exterior surface;
a plurality of cooling chambers containing polymer crystals attached to the inner surface of said air permeable sleeve, each cooling chamber being spaced from an adjacent cooling chamber.

2. The cooling apparatus of claim 1 wherein each cooling chamber includes at least one cell comprised of a water permeable material, the cell containing a predetermined amount of polymer crystals.

3. The cooling apparatus of claim 2 wherein the cooling chamber includes first and second contiguous cells.

4. The cooling apparatus of claim 2 wherein the at least one cell is comprised of canvass.

5. The cooling chamber of claim 2 wherein the cell includes a teaspoon of polymer crystals.

6. The cooling chamber of claim 2 wherein said sleeve comprises a mesh fabric.

7. A cooling apparatus for intravenous fluids comprising:
a flexible, air permeable sleeve having an interior surface and an exterior surface and an upstream end portion and downstream end portion;
an IV bag loop attached to the interior surface of said sleeve proximate the upstream end portion;
a administration assembly attached to said sleeve proximate the downstream end portion; and
a plurality of cooling chambers containing polymer crystals disposed on the inner surface of said air permeable sleeve, each cooling chamber being spaced from an adjacent cooling chamber.

8. The cooling apparatus of claim 7 wherein said administration assembly includes an administration port adapted to receive a drip set port of an IV bag.

9. The cooling apparatus of claim 7 wherein the upper end portion of said sleeve includes an opening and further comprising fasteners attached to the interior surface of said sleeve proximate to the opening.

10. The cooling apparatus of claim 7 further comprising a hanging strap attached to the upstream end portion of said sleeve.

11. The cooling apparatus of claim 7 wherein each cooling chamber includes at least one cell comprised of a water permeable material, the cell containing a predetermined amount of polymer crystals.

12. The cooling apparatus of claim 7 wherein said cooling chambers are fixedly attached to the interior surface of said sleeve.

13. The cooling apparatus of claim 7 wherein said cooling chambers are removably attached to the interior surface of said sleeve.

14. The cooling apparatus of claim 11 wherein the cooling chamber includes first and second contiguous cells.

15. The cooling apparatus of claim 11 wherein the at least one cell is comprised of canvass.

16. The cooling chamber of claim 11 wherein the cell includes a teaspoon of polymer crystals.

17. The cooling chamber of claim 11 wherein said sleeve comprises a mesh fabric.

18. An evaporative cooling apparatus for IV fluids comprising:
a flexible, air permeable sleeve configured to receive an IV bag, said sleeve having an interior surface and an exterior surface;
a plurality of cooling chambers containing polymer crystals attached to the inner surface of said air permeable sleeve, each cooling chamber being spaced from an adjacent cooling chamber; and
an IV bag insertion port disposed in said sleeve, said insertion port including a closure mechanism for constricting said sleeve and urging said cooling chambers against an IV bag.

19. The cooling apparatus of claim 16 wherein the closure mechanism includes a drawstring threaded through a perimeter of said insertion port.
